(19) United States
(12) Patent Application Publication
(10) Pub. No.: US 2007/0235704 A1
(43) Pub. Date: Oct. 11, 2007

(54) Hydraulic Jack Extender

(76) Inventor: Michael A. Paul, Merrill, WI (US)

Correspondence Address: LANE PATENTS LLC, 100 NORTH 72ND AVE., SUITE 107, WAUSAU, WI, 54401, US

(21) Appl. No.: 11/733,883

(22) Filed: Apr. 11, 2007

Related U.S. Application Data
(60) Provisional application No. 60/744,661, filed on Apr. 11, 2006.

(51) Int. Cl. B60P 1/48

(52) U.S. Cl. 254/8 B

(57) ABSTRACT

An extender for hydraulic jacking systems. It increases the clearance under the raised object for increased access and mobility. It is easily installed and removed from commercially available systems.

### CROSS-REFERENCE TO RELATED APPLICATIONS

The present application is a continuation of U.S. provisional patent application Ser. No. 60/744,661 included by reference herein and for which benefit of the priority date is hereby claimed.

### BACKGROUND OF THE INVENTION

1. Field of the Invention

The present invention relates to the field of lifting devices, in particular hydraulic jack systems such as those used with vehicles such as automobiles, pick-up trucks, ATVs, recreational vehicles and the like it increases the height that the body of the vehicle can be raised from it's supporting surface allowing increased access to the underside of the vehicle.

2. Description of the Related Art

Previously hydraulic floor jacks have been used in automotive garages or service stations to raise vehicle bodies from a floor for repairs, inspections, or cleaning for example. Some types of high clearance vehicles, such as four wheel drive or ATV's and the like are situated such that the jack has to come a long way from the floor in order to even engage the lifting structure of the vehicle. The extra work involved in raising the jack to meet the vehicle is tedious. Then when the vehicle is lifted from the floor the maximum height it can be raised is diminished by the length the jack needed to be raised in order to engage the vehicle.

Traditionally technicians have used spacers such as blocks of wood or other bulky items found in the vicinity of the garage. They have been unstable, unsafe, and unreliable.

In other cases the floor jack needs to be extended beyond it's designed extension to allow space, for intensive work such us pulling engines or transmissions and the like.

It would be good to have a solution that provides a safe, reliable, extension to improve the reach of a standard, commercially available hydraulic jack in order to increase the height of its lift.

### DESCRIPTION OF THIS INVENTION (ART)

### SUMMARY

The principle object of this invention is to provide a removable attachment for a hydraulic jack system that maximizes that jacks potential to raise a so-called high clearance vehicle to allow access to the undercarriage.

### OBJECTS AND ADVANTAGES

This floor jack attachment is designed to work with any floor jack that comes with a removable pad. It is operated by removing the standard resting pad from the floor jack and replacing it with the current invention.

This invention gives the advantage of raising the vehicle body by up to an additional 10 inches.

This invention gives the further advantage of being able to support the weight of any standard vehicle in a stable and safe manor. In fact, this invention has proven safer for users in regard to scraped or injured knuckles due to the wider range of movement.

A further advantage is that it can be used privately for the home owner in any application that would require a floor jack, by giving extra room for work or movement.

There are no moving parts to break or wear out. In fact, the design, materials, and construction, of the this invention are such that it should outlast the lifespan of the original owner and be passed down from generation to generation.

In addition the central support structure makes a great handle for carrying the jack extender.

### DRAWING FIGURES

FIG. 1 shows a perspective view of a hydraulic jack with jack extension in operational position according to a first embodiment of the present invention.

FIG. 2 shows a perspective view of a hydraulic jack with jack extension removed.

FIG. 3 shows a perspective view of a jack extension according to a first embodiment of the present invention.

FIG. 4 shows a top down view of the present embodiment.

FIG. 5 shows a front view of the present embodiment.

FIG. 6 shows a side view of the present embodiment.

### REFERENCE NUMERALS IN DRAWINGS

10—jack extension

11—hydraulic jack

12—support base

14—sidewall support structure

16—central support structure

18—registration pin

20—cleat

22—top support surface

24—jack mount opening

26—rest plate

### DESCRIPTION

### FIGS Preferred Embodiment

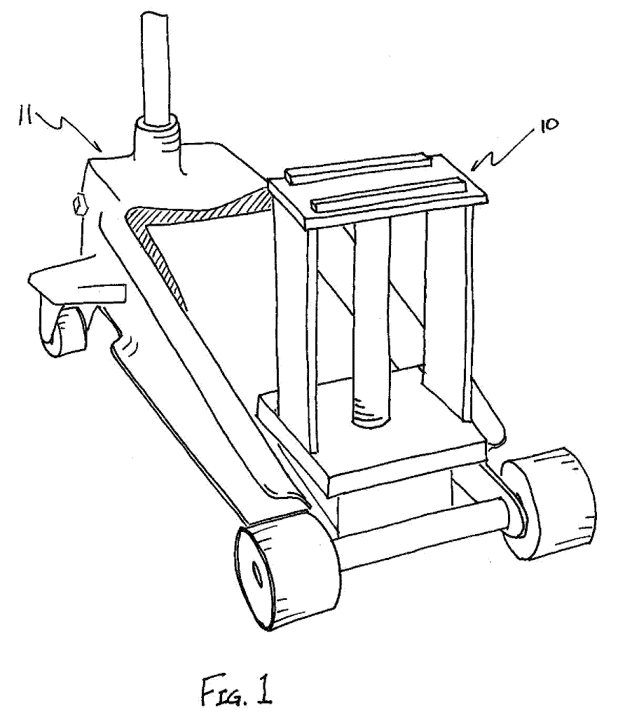

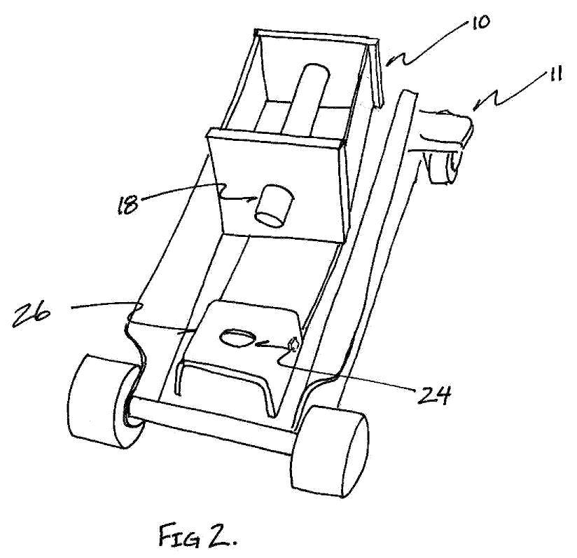

FIG. 1 shows the jack extension (10) mounted on an industry standard hydraulic jack (11). FIG. 2 shows how the jack extension is mounted and held in place by inserting a registration pin (18) of the jack extension into a jack mount opening (24) of a rest plate (26) of the hydraulic jack (11). This registration pin (18) centers the load of the vehicle that is transferred through the jack extension (10) over the rest plate (26) and stabilizes the load.

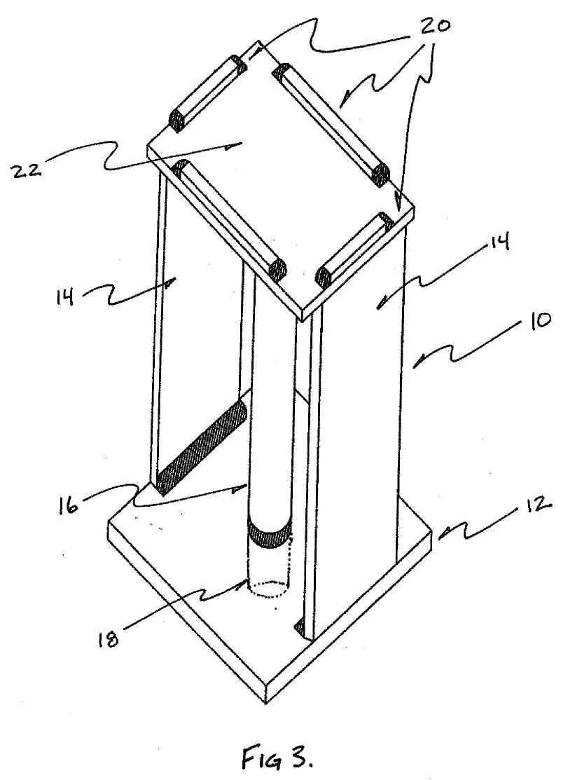

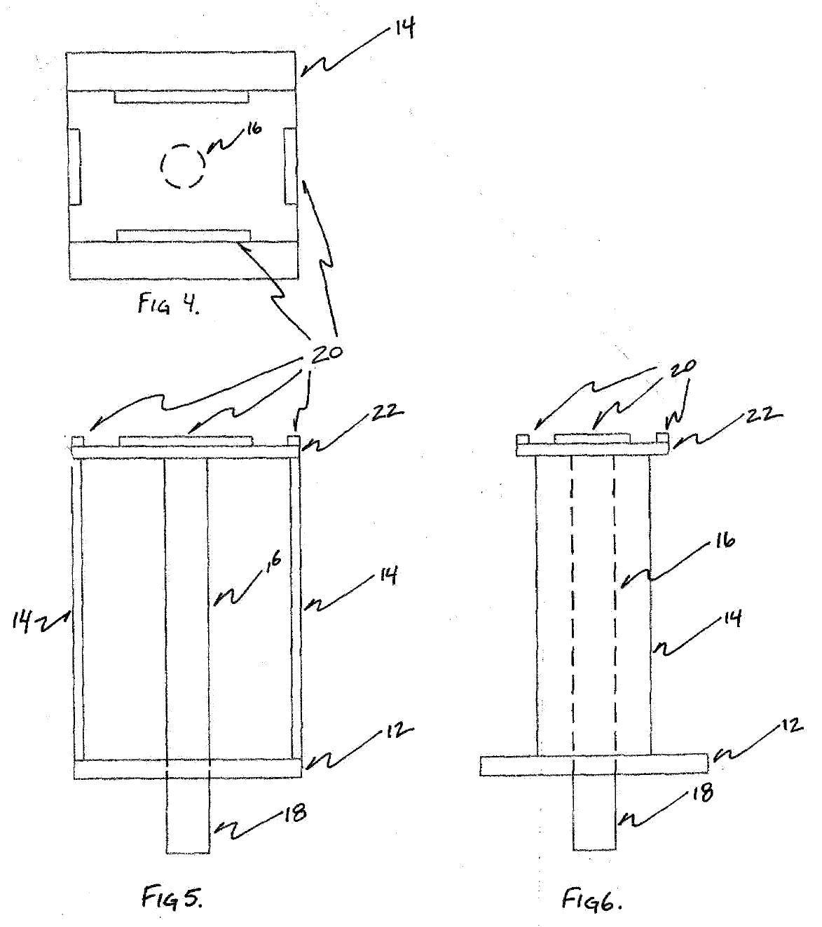

FIGS. 3, 4 and 5 show elements of the jack extension (10) which consists of; a support base (12) which has mounted a plurality of sidewall support structures (14) and one or more additional support structures (16) to transfer the load of a vehicle which rests upon a top support surface (22). Optionally, a cleat structure (20) may be added to further secure the vehicle on the top support surface (22).

Approximate dimensions for a preferred embodiment of the jack extension (10) would be approximately 9¼ inches tall, 6 inches long, and 3 inches wide. The support base can be made from approximately a ¾ inch plate steel for connection of the sidewall support structures. Directed straight upward through the center of the product would be an approximately 1⅛ inch diameter steel pipe with the bottom end extended beneath the center of the support base. The ultimate size of the registration pin would depend upon the jack mount opening diameter.

### FIGS Additional Embodiments

The potential exists for additional embodiments in ways which would make it more appealing to a wider range of end users. This could include producing the strong steel device in different sizes personalized for different floor jacks.

Multiple jack extensions may be used in conjunction to support a vehicle using an industrial center piston jack structure,

The height of the product and corresponding increase in floor jack lifting action might also vary.

Other means of securing the registration pin to the rest plate may also be employed, such as clevis pins or clamps.

### Conclusion, Ramifications, and Scope

Although the present invention has been described in detail, those skilled in the art will understand that various changes substitutions, and alterations herein may be made without departing from the spirit and scope of the invention in its broadest form.

1. A hydraulic jack extension which comprises:
(a) a support base,
(b) a plurality of sidewall support structures, each support structure being mounted orthogonally to the support base,
(c) a registration pin, for mounting mounted into a jack mount opening,
(d) and a top support surface.

2. A hydraulic jack extension as in claim 1 including a central support structure.

3. (canceled)

4. A hydraulic jack extension as in claim 3 wherein the registration pin is secured in place using a clevis pin.

5. A hydraulic jack extension as in claim 3 wherein the support base is secured to the rest plate using a clamp.

6. A method for extending the range of a hydraulic jack with a jack mount opening comprising the steps of;
(a) removing a standard resting pad from the rest plate
(b) mounting a jack extension by inserting a registration pin of said jack mount extension into a jack mount opening in said rest plate.

7. A hydraulic jack extension as in claim 1 including a cleat.

8. A hydraulic Jack extension as in claim 2 including a cleat.
